(19) United States
(12) Patent Application Publication
(10) Pub. No.: US 2025/0348407 A1
(43) Pub. Date: Nov. 13, 2025

(54) MANAGING MODULE INTERACTION IN A MACHINE LEARNING SYSTEM

(71) Applicant: Kinaxis Inc., Ottawa (CA)

(72) Inventors: Kevin Wye-Lim Chan, Toronto (CA); Nizar Mabroukeh, Burlington (CA); Ayaz Nakhuda, Brampton (CA)

(73) Assignee: Kinaxis Inc., Ottawa (CA)

(21) Appl. No.: 19/196,238

(22) Filed: May 1, 2025

Related U.S. Application Data
(60) Provisional application No. 63/643,560, filed on May 7, 2024.

(51) Int. Cl. G06F 11/3604

(52) U.S. Cl. CPC G06F 11/3608

(57) ABSTRACT

Systems and methods in which a training dataset of a trained tree-based model is embedded as an array of vectors, where each dimension represents a decision point in the model; a distance between historical sample points in a time series is defined as a cosine similarity function between two of these vectors; the array of vectors is processed through a Hierarchical Navigable Small World index, thereby producing an approximate view of similar vectors; for a new prediction, there is a search for a number of most similar vectors; and a discrete probability distribution is created.

The present application claims the benefit of U.S. Provisional Patent Application No. 63/643,560 filed May 7, 2024, which is expressly incorporated by reference in its entirety herein.

### BACKGROUND

Machine learning systems can be used to manage data and programs associated with machine learning (ML) models. A machine learning system may include a plurality of modules that interact with one another to train and operate one or more ML models to achieve a desired outcome.

As machine learning systems become increasingly complex, there is a challenge of correctly capturing relationships between different modules of a machine learning system. Incorrectly capturing module relationships can become a major issue for developers in production time.

Improvements are desirable in approaches for managing module interaction in a machine learning system.

### BRIEF SUMMARY

In one aspect, a computing apparatus for managing interactions between modules in a machine learning system is provided, The apparatus includes a processor. The computing apparatus also includes a memory storing instructions that, when executed by the processor, configure the apparatus to: obtain, by the processor, a module interaction specification defining expected parameters for interaction between a first module and a second module in the machine learning system; obtain, by the processor, module interaction data associated with detected interaction between the first module and the second module; automatically test the module interaction data against the module interaction specification; and prevent or permit continued interaction between the first module and the second module based on the testing of the module interaction data against the module interaction specification.

The computing apparatus may also include where the instructions further configure the apparatus to prevent continued interaction between the first module and the second module based on the testing indicating that the module interaction data failed to meet the module interaction specification.

The computing apparatus may also include where the instructions further configure the apparatus to permit continued interaction between the first module and the second module based on the testing indicating that the module interaction data meets the module interaction specification.

The computing apparatus may also include where the instructions further configure the apparatus to: obtain, as part of the module interaction specification, expected parameters for interaction between a first artifact type in the first module and a second artifact type in the second module; and prevent or permit continued interaction between the first module and the second module based on testing of the module interaction data against the module interaction specification with respect to the first artifact type in the first module and the second artifact type in the second module.

The computing apparatus may also include where the instructions further configure the apparatus to: obtain, as part of the module interaction specification, expected parameters for interaction between a first set of artifacts in the first module and a second set of artifacts in the second module; and prevent or permit continued interaction between the first module and the second module based on testing of the module interaction data against the module interaction specification with respect to the first set of artifacts in the first module and the second set of artifacts in the second module.

The computing apparatus may also include where the module interaction specification includes a contract defining expected parameters for interaction between the first module and the second module.

The computing apparatus may also include where automatically testing the module interaction data against the module interaction specification is performed in response to detection of a software code modification relating to the first module or the second module.

The computing apparatus may also include where automatically testing the module interaction data against the module interaction specification is performed in response to a runtime request to consume an artifact and prior to consuming the artifact.

The computing apparatus may also include where obtaining the module interaction specification, obtaining the module interaction data, automatically testing the module interaction data against the module interaction specification, and preventing or permitting continued interaction between the first module and the second module are performed in a continuous integration pipeline for software development.

The computing apparatus may also include where obtaining the module interaction specification, obtaining the module interaction data, automatically testing the module interaction data against the module interaction specification, and preventing or permitting continued interaction between the first module and the second module are performed in the first module or in the second module. Other technical features may be readily apparent to one skilled in the art from the following figures, descriptions, and claims.

In one aspect, a non-transitory computer-readable storage medium for managing interactions between modules in a machine learning system is provided, the computer-readable storage medium including instructions that when executed by a computer, cause the computer to: obtain, by a processor, a module interaction specification defining expected parameters for interaction between a first module and a second module in the machine learning system; obtain, by the processor, module interaction data associated with detected interaction between the first module and the second module; automatically test the module interaction data against the module interaction specification; and prevent or permit continued interaction between the first module and the second module based on the testing of the module interaction data against the module interaction specification.

The computer-readable storage medium may also include where the instructions further configure the computer to prevent continued interaction between the first module and the second module based on the testing indicating that the module interaction data failed to meet the module interaction specification.

The computer-readable storage medium may also include where the instructions further configure the computer to permit continued interaction between the first module and the second module based on the testing indicating that the module interaction data meets the module interaction specification.

The computer-readable storage medium may also include where the instructions further configure the computer to: obtain, as part of the module interaction specification, expected parameters for interaction between a first artifact type in the first module and a second artifact type in the second module; and prevent or permit continued interaction between the first module and the second module based on testing of the module interaction data against the module interaction specification with respect to the first artifact type in the first module and the second artifact type in the second module.

The computer-readable storage medium may also include where the instructions further configure the computer to: obtain, as part of the module interaction specification, expected parameters for interaction between a first set of artifacts in the first module and a second set of artifacts in the second module; and prevent or permit continued interaction between the first module and the second module based on testing of the module interaction data against the module interaction specification with respect to the first set of artifacts in the first module and the second set of artifacts in the second module.

The computer-readable storage medium may also include where the module interaction specification includes a contract defining expected parameters for interaction between the first module and the second module.

The computer-readable storage medium may also include where automatically testing the module interaction data against the module interaction specification is performed in response to detection of a software code modification relating to the first module or the second module.

The computer-readable storage medium may also include where automatically testing the module interaction data against the module interaction specification is performed in response to a runtime request to consume an artifact and prior to consuming the artifact.

The computer-readable storage medium may also include where obtaining the module interaction specification, obtaining the module interaction data, automatically testing the module interaction data against the module interaction specification, and preventing or permitting continued interaction between the first module and the second module are performed in a continuous integration pipeline for software development.

The computer-readable storage medium may also include where obtaining the module interaction specification, obtaining the module interaction data, automatically testing the module interaction data against the module interaction specification, and preventing or permitting continued interaction between the first module and the second module are performed in the first module or in the second module. Other technical features may be readily apparent to one skilled in the art from the following figures, descriptions, and claims.

In one aspect, a computer-implemented method of managing interactions between modules in a machine learning system is provided, the method includes: obtaining, by a processor, a module interaction specification defining expected parameters for interaction between a first module and a second module in the machine learning system; obtaining, by the processor, module interaction data associated with detected interaction between the first module and the second module; automatically testing the module interaction data against the module interaction specification; and preventing or permitting continued interaction between the first module and the second module based on the testing of the module interaction data against the module interaction specification.

The computer-implemented method may also further include preventing continued interaction between the first module and the second module based on the testing indicating that the module interaction data failed to meet the module interaction specification.

The computer-implemented method may also further include permitting continued interaction between the first module and the second module based on the testing indicating that the module interaction data meets the module interaction specification.

The computer-implemented method may also further include: obtaining, as part of the module interaction specification, expected parameters for interaction between a first artifact type in the first module and a second artifact type in the second module; and preventing or permitting continued interaction between the first module and the second module based on testing of the module interaction data against the module interaction specification with respect to the first artifact type in the first module and the second artifact type in the second module.

The computer-implemented method may also further include: obtaining, as part of the module interaction specification, expected parameters for interaction between a first set of artifacts in the first module and a second set of artifacts in the second module; and preventing or permitting continued interaction between the first module and the second module based on testing of the module interaction data against the module interaction specification with respect to the first set of artifacts in the first module and the second set of artifacts in the second module.

The computer-implemented method may also include where the module interaction specification includes a contract defining expected parameters for interaction between the first module and the second module.

The computer-implemented method may also include where the module interaction specification includes a contract defining expected parameters for interaction between the first module and the second module.

The computer-implemented method may also include where automatically testing the module interaction data against the module interaction specification is performed in response to a runtime request to consume an artifact and prior to consuming the artifact.

The computer-implemented method may also include where obtaining the module interaction specification, obtaining the module interaction data, automatically testing the module interaction data against the module interaction specification, and preventing or permitting continued interaction between the first module and the second module are performed in a continuous integration pipeline for software development.

The computer-implemented method may also include where obtaining the module interaction specification, obtaining the module interaction data, automatically testing the module interaction data against the module interaction specification, and preventing or permitting continued interaction between the first module and the second module are performed in the first module or in the second module. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Like reference numbers and designations in the various drawings indicate like elements.

FIG. 1 illustrates an example of a system for managing module interaction in a machine learning system in accordance with one embodiment.

FIG. 2 is a flowchart illustrating a routine for managing interactions between modules in a machine learning system in accordance with one embodiment.

FIG. 3 is a block and flow diagram illustrating module interaction in a machine learning system in accordance with one embodiment.

FIG. 4 is a block and flow diagram illustrating module interaction in a machine learning system in accordance with one embodiment.

### DETAILED DESCRIPTION

Several components or modules may run in a machine learning system. For the system to work properly, the modules or components must talk to each other in a certain way. For example, workflows may be written for the components to talk to each other, to achieve a certain functionality. Without waiting for another team to provide an output/input that a certain module needs, it is desirable to provide an assurance that this is the type of input the other module is going to provide (format, structure, data type), to enable development to be done based on the agreed-upon interactions. This can be encapsulated in a module interaction specification or contract.

Failure to correctly capture inter-module relationships may result in a significant loss of time and cloud compute at run time, for example by causing inefficient or incorrect interactions between modules. Incorrectly capturing module relationships may, as another example, result in a decrease in model performance due to a lack of correctly outlining or identifying certain artifacts within a certain module. Embodiments of the present disclosure solve one or more of these technical problems.

Embodiments of the present disclosure are configured to obtain or determine one or more module interaction specifications or contracts, and to run automated tests to check against the contracts to make sure each contract is met. When a request is made to add to the code, a system according to an embodiment of the present disclosure may be configured to check to make sure the new code to be added won't break a contract. In runtime, a system according to an embodiment of the present disclosure may be configured to, when tasked with processing or consuming an artifact, pause consumption of the artifact to first check the artifact against the contract or module interaction specification between the module tasked with consuming the artifact and the module from which the artifact has been obtained. For example, when a component is running in run time and tasked with consuming the artifact, instead of consuming the artifact, it first checks the artifact against the contract.

In an example implementation, one component or module may need to pull information from a previous run, and act on that component. Features may be generated by another component and create other artifacts. Embodiments of the present disclosure are configured to make sure that a contract defining interaction between these two components, also referred to as a module interaction specification, is honoured.

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non- limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

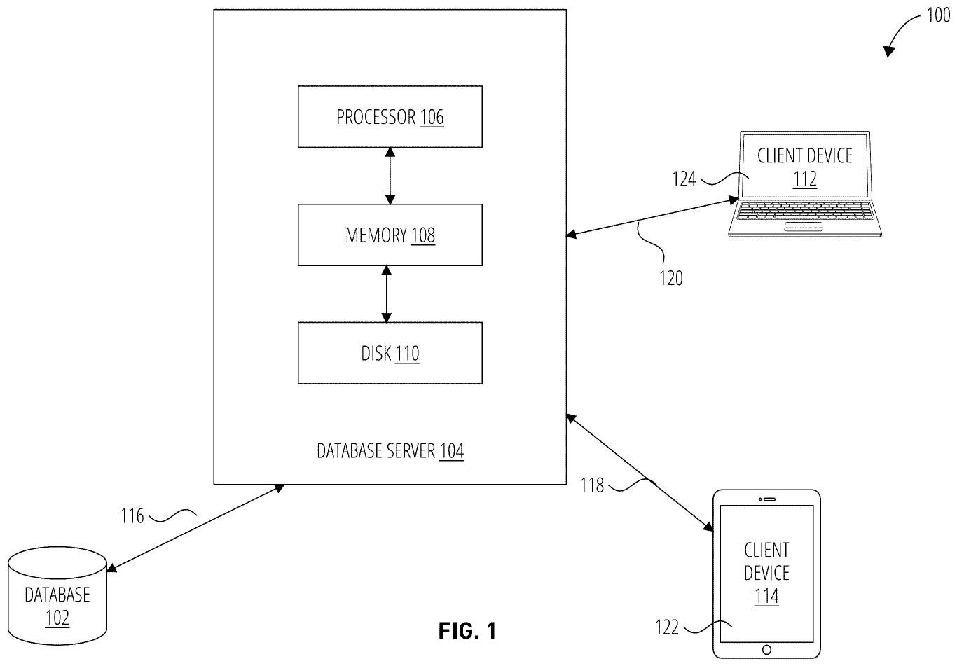

FIG. 1 illustrates an example of a system 100 for managing module interaction in a machine learning system in accordance with one embodiment.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

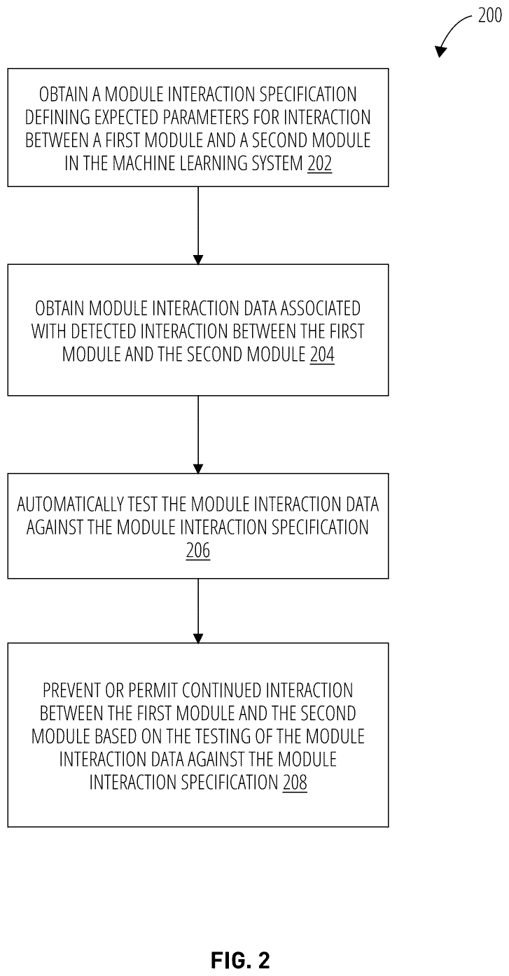

FIG. 2 is a flowchart illustrating a routine 200 for managing interactions between modules in a machine learning system in accordance with one embodiment. In block 202, routine 200 obtains, by a processor, a module interaction specification defining expected parameters for interaction between a first module and a second module in the machine learning system. In block 204, routine 200 obtains, by the processor, module interaction data associated with detected interaction between the first module and the second module. In block 206, routine 200 automatically tests the module interaction data against the module interaction specification. In block 208, routine 200 prevents or permits continued interaction between the first module and the second module based on the testing of the module interaction data against the module interaction specification. The module interaction specification may comprise a contract defining expected parameters for interaction between the first module and the second module. The method may also include generating, based on the testing of the module interaction data and the module specification, a module interaction result.

The method may include preventing continued interaction between the first module and the second module based on the testing indicating that the module interaction data failed to meet the module interaction specification. Preventing continued interaction in a case where the specification is not met helps to prevent a computer problem of the computer not working properly because of incompatible data interactions between modules in the ML system. The method may also include further include permitting continued interaction between the first module and the second module based on the testing indicating that the module interaction data meets the module interaction specification. Permitting continued interaction in a case where the specification is met helps to ensure proper functioning of the computer by ensuring compatible data interactions between modules in the ML system, with respect to the module interaction specification(s).

Different modules may comprise different artifacts, and the different artifacts may be classified as artifact types. For example, a first artifact type may comprise column metadata, and a second artifact type may comprise segment information. The method or routine 200 may include obtaining, as part of the module interaction specification, expected parameters for interaction between a first artifact type in the first module and a second artifact type in the second module. The method or routine 200 may include preventing or permitting continued interaction between the first module and the second module based on testing of the module interaction data against the module interaction specification with respect to the first artifact type in the first module and the second artifact type in the second module.

The module interaction specification may define an artifact schema including expected parameters for interaction between the first artifact type defining a first plurality of artifact attributes and the second artifact type defining a second plurality of artifact attributes. Each of the first plurality of artifact attributes may include an attribute name and an attribute type. Each of the second plurality of artifact attributes may also include an attribute name and an attribute type.

A plurality of modules may each comprise a set of artifacts. In such an embodiment, the method may include obtaining, as part of the module interaction specification, expected parameters for interaction between a first set of artifacts in the first module and a second set of artifacts in the second module. The method may include preventing or permitting continued interaction between the first module and the second module based on testing of the module interaction data against the module interaction specification with respect to the first set of artifacts in the first module and the second set of artifacts in the second module.

Different modules may be categorized according to different module types, for example an interface module or a training module. The module interaction specification may define expected parameters for interaction between a first module type and a second module type.

In an embodiment, automatically testing the module interaction data against the module interaction specification may be performed in response to detection of a software code modification relating to the first module or the second module. In another embodiment, automatically testing the module interaction data against the module interaction specification may be performed in response to a runtime request to consume an artifact and prior to consuming the artifact.

In an embodiment, obtaining the module interaction specification, obtaining the module interaction data, automatically testing the module interaction data against the module interaction specification, and preventing or permitting continued interaction between the first module and the second module are performed in a continuous integration pipeline for software development. In another embodiment, obtaining the module interaction specification, obtaining the module interaction data, automatically testing the module interaction data against the module interaction specification, and preventing or permitting continued interaction between the first module and the second module are performed in the first module or the second module.

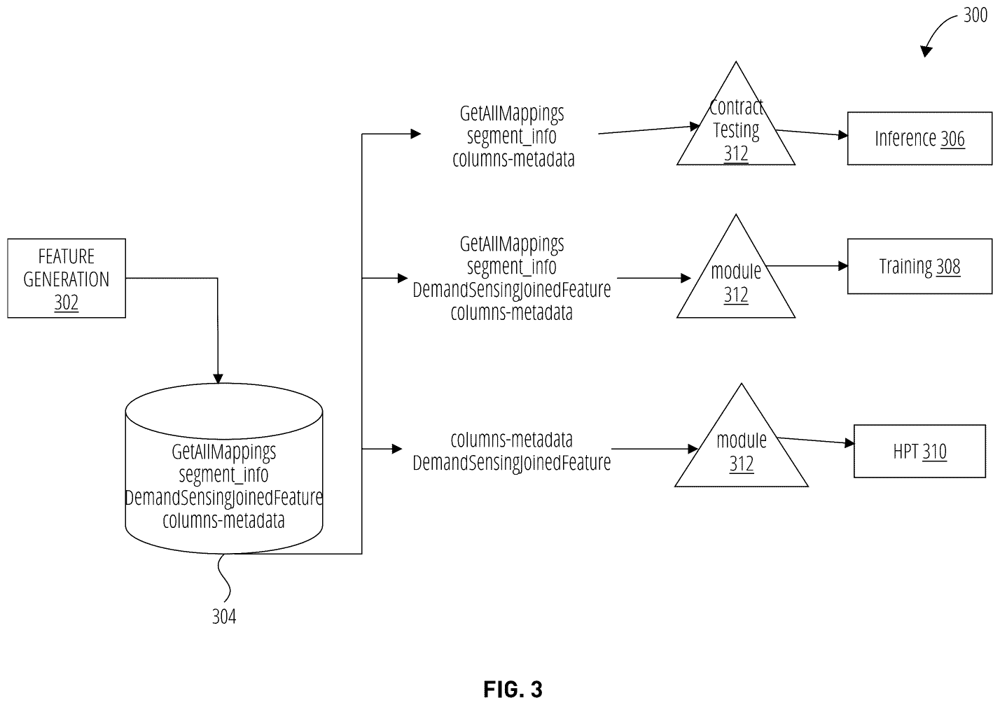

FIG. 3 is a block and flow diagram 300 illustrating module interaction in a machine learning system in accordance with one embodiment. Feature generation module 302 may be configured to produce a number of different artifacts. Different modules such as inference module 306, training module 308 and, hyperparameter testing (HPT) module 310 may be configured to obtain a varying number of artifacts output by feature generation module 302. The artifacts may be sent through one or more contract testing modules 312, where there is a specific contract or module interaction specification defined with respect to interaction between a pair of modules. For example, a JSON file may be configured to define the expected parameters relating to interaction between feature generation module 302 and training module 308.

One or more embodiments of the present disclosure may be configured to test module interaction data against the module interaction specification, or contract, by: 1) loading one or more artifacts held in storage, for example in module interaction database 304; 2) capturing module interaction data associated with the artifacts, in a format similar to the module interaction specification, to enable proper comparison; and 3) determining whether the module interaction data from the module interaction database 304 matches the expected parameters in the module interaction specification for a pair of modules. If the module interaction data does not match the expected parameters in the module interaction specification, this reveals a problem in that the interaction does not meet the specification.

In an example implementation, a separate module interaction specification is provided for each pair of modules interacting with one another. For example, in relation to FIG. 3: a first module interaction specification may be defined for interactions between feature generation module 302 and inference module 306; a second module interaction specification may be defined for interactions between feature generation module 302 and training module 308; and a third module interaction specification may be defined for interactions between feature generation module 302 and HPT module 310.

In each of the module interaction specifications, or contracts, each artifact may have different attributes. The obtained module interaction data may be compared to, or tested against, the expected parameters in the module interaction specification with respect to one or more artifact attributes. For example, inference module 306 and training module 308 both require the “segment_info” artifact from feature generation module 302. However, they may not require the same attributes with respect to the segment_info artifact. For example, segment_info may include attributes A, B and C, and inference module 306 may need attributes A and B from segment_info, but training module 308 may need attributes B and C. Just because an artifact is in two module interaction specifications does not mean that the same artifact attributes are desired or required by different modules. As an example, the same artifact could be valid for one contract between first and second modules and fail for another contract between first and third modules, even though the artifact is there, but different attributes or components may be needed by the different modules.

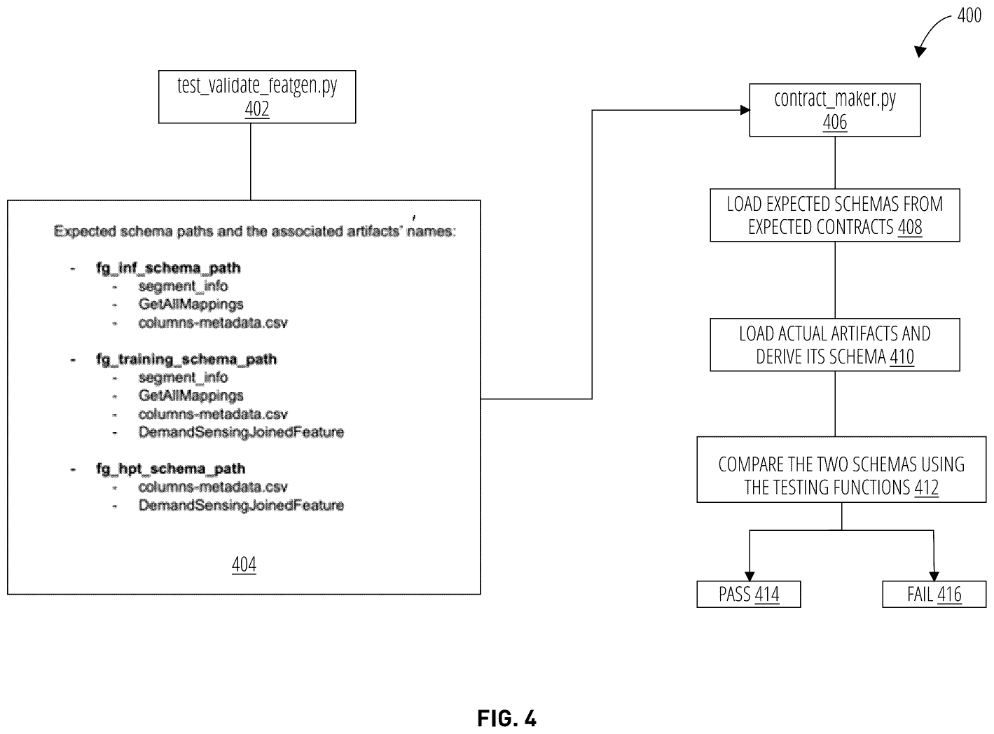

FIG. 4 is a block and flow diagram 400 illustrating module interaction in a machine learning system in accordance with one embodiment. As shown in FIG. 4, a first python code module 402 test_validate_featgen.py may comprise or define a module interaction specification 404. The module interaction specification 404 includes a plurality of artifacts, in this case three artifacts: fg_inf_schema_path; fg_training_schema_path; and fg_htp_schema_path. The module interaction specification may also include a plurality of attributes for each of the plurality of artifacts. For example: artifact fg_inf_schema_path includes artifacts segment_info, GetAllMappings, and columns-metadata.csv. Artifact fg_training_schema_path includes artifacts segment_info, GetAllMappings, columns-metadata.csv, and DemandSensingJoinedFeature. Artifact fg_htp_schema_path includes artifacts columns-metadata.csv and DemandSensingJoinedFeature.

As shown in FIG. 4, a second python code module 406 contract_maker.py may be configured to perform the following acts: 408 load expected schemas from expected contract, or load expected parameters from module interaction specification; 410 load actual artifacts and derive its schema; and 412 compare the two schemas using included testing functions. The result of 408, 410 and 412 may be a pass (414) or a fail (416) indication with respect to the data meeting the specification. Embodiments of the present disclosure provide a novelty over known approaches by comparing expected parameters in the module interaction specification with obtained or measured module interaction data to determine whether the contract or module interaction specification is being honoured. Failure to honor the contract may result in failing in runtime, or breaking the product even in development time. Embodiments of the present disclosure solve this computer problem by preventing interaction that would break the product and permitting interaction that ensures proper operation of the product.

According to one or more embodiments, functions such as actions 408, 410 and 412 may be implemented in a continuous integration pipeline that can load in the module interaction specification and the artifacts. In an example embodiment, the actions 408, 410 and 412 may be performed in the context of the continuous integration, as well as by the modules themselves. For example, a system according to one or more embodiments may run actions 408, 410 and 412 or similar functions in the CI to make sure nothing broke or did not comply with the module interaction specification before code is accepted. In another example, a system according to one or more embodiments may run actions 408, 410 and 412 in the module itself, such as to run a test when the module produces an output to make sure the output is valid. The functionality associated with running actions 408, 410 and 412 may be provided in the CI pipeline, or in one or more of the modules themselves, or both.

As indicated earlier, failure to correctly capture inter-module relationships may result in a significant loss of time and cloud compute at run time, for example by causing inefficient or incorrect interactions between modules. Such technical problems are common with respect to known approaches. Embodiments of the present disclosure solve this technical problem by providing elements that cooperate to correctly capture inter-module relationships, such as via a module interaction specification, and to monitor compliance with the specification by comparing module interaction data with the module interaction specification, and preventing or permitting continued interaction between ML system modules based on the testing of the module interaction data against the module interaction specification. Embodiments of the present disclosure provide a technical improvement by reducing the processor load and cost compared to existing approaches, as well as reducing the memory required.

Further, incorrectly capturing module relationships may, as another example, result in a decrease in model performance due to a lack of correctly outlining or identifying certain artifacts within a certain module. Embodiments of the present disclosure solve such a technical problem by providing a technical solution that monitors compliance with a specification by comparing module interaction data with a module interaction specification, and preventing or permitting continued interaction between ML system modules based on the testing of the module interaction data against the module interaction specification. In addition, the module interaction specification may include specifics regarding artifacts within a module, and may provide a technical improvement by monitoring compliance with respect to specific artifacts and preventing or permitting continued interaction between ML system modules based on the testing of the module interaction data against the module interaction specification. Embodiments of the present disclosure provide a technical improvement by providing improved processor and system performance, and avoiding scenarios which would decrease system performance due to data incompatibility in module interaction.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus for managing interactions between modules in a machine learning system, the apparatus comprising:
a processor; and
a memory storing instructions that, when executed by the processor, configure the apparatus to:
obtain, by the processor, a module interaction specification defining expected parameters for interaction between a first module and a second module in the machine learning system;
obtain, by the processor, module interaction data associated with detected interaction between the first module and the second module;
automatically test the module interaction data against the module interaction specification; and
prevent or permit continued interaction between the first module and the second module based on the testing of the module interaction data against the module interaction specification.

2. The computing apparatus of claim 1, wherein the instructions further configure the apparatus to:
prevent continued interaction between the first module and the second module based on the testing indicating that the module interaction data failed to meet the module interaction specification.

3. The computing apparatus of claim 1, wherein the instructions further configure the apparatus to:
permit continued interaction between the first module and the second module based on the testing indicating that the module interaction data meets the module interaction specification.

4. The computing apparatus of claim 1, wherein the instructions further configure the apparatus to:
obtain, as part of the module interaction specification, expected parameters for interaction between a first artifact type in the first module and a second artifact type in the second module; and
prevent or permit continued interaction between the first module and the second module based on testing of the module interaction data against the module interaction specification with respect to the first artifact type in the first module and the second artifact type in the second module.

5. The computing apparatus of claim 1, wherein the instructions further configure the apparatus to:
obtain, as part of the module interaction specification, expected parameters for interaction between a first set of artifacts in the first module and a second set of artifacts in the second module; and
prevent or permit continued interaction between the first module and the second module based on testing of the module interaction data against the module interaction specification with respect to the first set of artifacts in the first module and the second set of artifacts in the second module.

6. (canceled)

7. The computing apparatus of claim 1, wherein automatically testing the module interaction data against the module interaction specification is performed in response to detection of a software code modification relating to the first module or the second module.

8. The computing apparatus of claim 1, wherein automatically testing the module interaction data against the module interaction specification is performed in response to a runtime request to consume an artifact and prior to consuming the artifact.

9. (canceled)

10. (canceled)

11. A non-transitory computer-readable storage medium for managing interactions between modules in a machine learning system, the computer-readable storage medium including instructions that when executed by a computer, cause the computer to:
obtain, by a processor, a module interaction specification defining expected parameters for interaction between a first module and a second module in the machine learning system;
obtain, by the processor, module interaction data associated with detected interaction between the first module and the second module;
automatically test the module interaction data against the module interaction specification; and
prevent or permit continued interaction between the first module and the second module based on the testing of the module interaction data against the module interaction specification.

12. The computer-readable storage medium of claim 11, wherein the instructions further configure the computer to:
prevent continued interaction between the first module and the second module based on the testing indicating that the module interaction data failed to meet the module interaction specification.

13. The computer-readable storage medium of claim 11, wherein the instructions further configure the computer to:
permit continued interaction between the first module and the second module based on the testing indicating that the module interaction data meets the module interaction specification.

14. The computer-readable storage medium of claim 11, wherein the instructions further configure the computer to:
obtain, as part of the module interaction specification, expected parameters for interaction between a first artifact type in the first module and a second artifact type in the second module; and
prevent or permit continued interaction between the first module and the second module based on testing of the module interaction data against the module interaction specification with respect to the first artifact type in the first module and the second artifact type in the second module.

15. The computer-readable storage medium of claim 11, wherein the instructions further configure the computer to:
obtain, as part of the module interaction specification, expected parameters for interaction between a first set of artifacts in the first module and a second set of artifacts in the second module; and
prevent or permit continued interaction between the first module and the second module based on testing of the module interaction data against the module interaction specification with respect to the first set of artifacts in the first module and the second set of artifacts in the second module.

16. (canceled)

17. The computer-readable storage medium of claim 11, wherein automatically testing the module interaction data against the module interaction specification is performed in response to detection of a software code modification relating to the first module or the second module.

18. The computer-readable storage medium of claim 11, wherein automatically testing the module interaction data against the module interaction specification is performed in response to a runtime request to consume an artifact and prior to consuming the artifact.

19. (canceled)

20. (canceled)

21. A computer-implemented method of managing interactions between modules in a machine learning system, the method comprising:
obtaining, by a processor, a module interaction specification defining expected parameters for interaction between a first module and a second module in the machine learning system;
obtaining, by the processor, module interaction data associated with detected interaction between the first module and the second module;
automatically testing the module interaction data against the module interaction specification; and
preventing or permitting continued interaction between the first module and the second module based on the testing of the module interaction data against the module interaction specification.

22. The computer-implemented method of claim 21, further comprising:
preventing continued interaction between the first module and the second module based on the testing indicating that the module interaction data failed to meet the module interaction specification.

23. The computer-implemented method of claim 21, further comprising:
permitting continued interaction between the first module and the second module based on the testing indicating that the module interaction data meets the module interaction specification.

24. The computer-implemented method of claim 21, further comprising:
obtaining, as part of the module interaction specification, expected parameters for interaction between a first artifact type in the first module and a second artifact type in the second module; and
preventing or permitting continued interaction between the first module and the second module based on testing of the module interaction data against the module interaction specification with respect to the first artifact type in the first module and the second artifact type in the second module.

25. The computer-implemented method of claim 21, further comprising:
obtaining, as part of the module interaction specification, expected parameters for interaction between a first set of artifacts in the first module and a second set of artifacts in the second module; and
preventing or permitting continued interaction between the first module and the second module based on testing of the module interaction data against the module interaction specification with respect to the first set of artifacts in the first module and the second set of artifacts in the second module.

26. (canceled)

27. The computer-implemented method of claim 21, wherein the module interaction specification comprises a contract defining expected parameters for interaction between the first module and the second module.

28. The computer-implemented method of claim 21, wherein automatically testing the module interaction data against the module interaction specification is performed in response to a runtime request to consume an artifact and prior to consuming the artifact.

29. (canceled)

30. (canceled)
